(19) United States
(12) Patent Application Publication
(10) Pub. No.: US 2021/0264423 A1
(43) Pub. Date: Aug. 26, 2021

(54) SYSTEMS AND METHODS FOR AUTOMATICALLY INITIATING CHARGEBACK TRANSACTIONS FOR DUAL MESSAGE TRANSACTIONS

(71) Applicant: MASTERCARD INTERNATIONAL INCORPORATED, Purchase, NY (US)

(72) Inventors: Patricia Rohlfing, Winfield, MO (US); Joan Lee Rohlfing, Maryland Heights, MO (US); Desh Deepak Yog, O'Fallon, MO (US); Michael Scott Powell, Eureka, MO (US)

(21) Appl. No.: 16/797,992

(22) Filed: Feb. 21, 2020

(51) Int. Cl. G06Q 20/40; G06Q 40/02; G06Q 30/00; G06F 16/25; G06F 16/23

(52) U.S. Cl. CPC G06Q 20/407; G06Q 40/02; G06F 16/2379; G06Q 20/405; G06F 16/258; G06Q 30/018

(57) ABSTRACT

A computing system for automatically initiating a chargeback transaction from a plurality of processed transactions is provided. The computing system comprises a processor in communication with a memory, and the processor is programmed to: (i) receive transaction data associated with a plurality of processed transactions, the transaction data including a plurality of account identifiers, a plurality of authorization messages, and a plurality of clearing messages associated with the plurality of processed transactions, (ii) match the plurality of authorization messages with the respective plurality of clearing messages for each processed transaction of the plurality of processed transactions, (iii) identify automatic chargeback-eligible transactions from the plurality of processed transactions by parsing the transaction data and by the matching of the authorization messages with the clearing messages, (iv) store the identified automatic chargeback-eligible transactions, and (v) automatically initiate a chargeback transaction for each identified automatic chargeback-eligible transaction.

### BACKGROUND

The present application relates generally to chargeback disputes and, more specifically, to a network-based system and method for automatically determining chargeback-eligible transactions for dual message transactions and automatically initiating the chargeback transactions.

Occasionally, disputable transactions may be processed over a payment network. A disputable transaction includes transactions that are eligible to be disputed by a cardholder or an issuer, such as fraudulent transactions, transactions carried out with bad standing accounts, etc. For example, a cardholder may determine that a fraudulent transaction (e.g., a transaction not initialed by the cardholder or with permission from the cardholder) was made using a payment account of the cardholder, and/or users associated with a payment processing network may determine that purchases were made using payment accounts associated with an issuer that do not exist. In some cases, chargebacks may be requested for such disputable and fraudulent transactions by an issuer of the payment accounts. The issuer may submit a chargeback request to an issuer processor, and the issuer processor may submit the chargeback request to a payment card network for further processing the chargeback.

Typical systems of determining that disputable transactions require chargebacks require substantial human effort. Specifically, either cardholders have to carefully review statements of their payment accounts to determine that each transaction is legitimate, or users associated with a payment processing network have to research and review transaction data to determine that each processed transaction was carried out by a legitimate payment account. When cardholders and/or issuers identify disputable transactions and initiate chargeback requests, the chargeback requests must be manually reviewed, determined to be legitimate, and initiated through the chargeback transaction process. Accordingly, typical systems for determining that disputable transactions require chargebacks and initiating the chargeback transaction process are very time consuming, manual, and susceptible to human error.

It is desirable to provide a method and system for automatically initiating chargeback transactions from a plurality of processed transactions based upon the transactions satisfying one or more rules or requirements that are used to identify certain transactions as being automatic chargeback-eligible transactions.

### BRIEF DESCRIPTION

In one aspect, a computing system for automatically initiating a chargeback transaction from a plurality of processed transactions is provided. The computing system comprises at least one processor in communication with at least one memory, and the at least one processor is programmed to: (i) receive transaction data associated with a plurality of processed transactions, the transaction data including a plurality of account identifiers, a plurality of authorization messages, and a plurality of clearing messages associated with the plurality of processed transactions, (ii) match the plurality of authorization messages with the respective plurality of clearing messages for each processed transaction of the plurality of processed transactions, (iii) identify automatic chargeback-eligible transactions from the plurality of processed transactions by parsing the transaction data and by the matching of the authorization messages with the clearing messages, (iv) store, in the at least one memory, the identified automatic chargeback-eligible transactions, and (v) automatically initiate a chargeback transaction for each identified automatic chargeback-eligible transaction.

In another aspect, a computer-implemented method for automatically initiating a chargeback transaction from a plurality of processed transactions is provided. The method is implemented by a computing system including at least one processor in communication with at least one memory, and the method includes: (i) receiving transaction data associated with a plurality of processed transactions, the transaction data including a plurality of account identifiers, a plurality of authorization messages, and a plurality of clearing messages associated with the plurality of processed transactions, (ii) matching the plurality of authorization messages with the respective plurality of clearing messages for each processed transaction of the plurality of processed transactions, (iii) identifying automatic chargeback-eligible transactions from the plurality of processed transactions by parsing the transaction data and by the matching of the authorization messages with the clearing messages, (iv) storing, in the at least one memory, the identified automatic chargeback-eligible transactions, (v) automatically initiating a chargeback transaction for each identified automatic chargeback-eligible transaction.

In yet another aspect, at least one non-transitory computer-readable storage media that includes computer-executable instructions for automatically initiating a chargeback transaction from a plurality of processed transactions is provided. When executed by a computing system including at least one processor in communication with at least one memory, the computer-executable instructions cause the at least one processor to: (i) receive transaction data associated with a plurality of processed transactions, the transaction data including a plurality of account identifiers, a plurality of authorization messages, and a plurality of clearing messages associated with the plurality of processed transactions, (ii) match the plurality of authorization messages with the respective plurality of clearing messages for each processed transaction of the plurality of processed transactions, (iii) identify automatic chargeback-eligible transactions from the plurality of processed transactions by parsing the transaction data and by the matching of the authorization messages with the clearing messages, (iv) store, in the at least one memory, the identified automatic chargeback-eligible transactions, and (v) automatically initiate a chargeback transaction for each identified automatic chargeback-eligible transaction.

### BRIEF DESCRIPTION OF THE DRAWINGS

FIGS. 1-8 show example embodiments of the methods and systems described herein.

FIG. 1 is a schematic diagram illustrating an example multi-party payment account system for enabling payment transactions with an automatic chargeback (AC) computing device for collecting transaction data and automatically initiating chargebacks transactions in accordance with one embodiment of the present disclosure.

FIG. 2 is a block diagram of an example embodiment of an automatic chargeback (AC) platform including the AC computing device shown in FIG. 1.

FIGS. 3A and 3B are block diagrams illustrating an example process of determining automatic chargeback-eligible transactions and automatically initiating the chargeback transactions by the AC computing device shown in FIG. 1.

FIG. 4 is a simplified diagram of an example database entry including transaction data generated by the AC computing device shown in FIG. 1.

FIG. 5 is an example configuration of a client system shown in FIG. 2.

FIG. 6 is an example configuration of a server system shown in FIG. 2.

FIG. 7 is a diagram of components of one or more example computing devices that may be used in the AC platform shown in FIG. 2.

FIG. 8 is a simplified diagram of an example method for collecting transaction data and automatically initiating chargeback transactions using the AC computing device of FIG. 2.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION

The systems and methods described herein are directed to automatically initiating a chargeback transaction from a plurality of processed transactions based upon one or more rules and/or requirements used to identify certain transactions of the plurality of transactions as chargeback-eligible transactions. In the example embodiment, the plurality of processed transactions includes dual message transactions (e.g., transactions including an authorization message and a clearing message), debit transactions (e.g., carried out with a credit card and/or a debit card), and prepaid transactions that have been processed by a payment processor. In one example embodiment, the systems and methods may be performed by an automatic chargeback (AC) computing device. The AC computing device may be in communication with the payment processor and one or more issuers.

In automatically initiating chargeback transactions, the AC computing device may determine whether the plurality of processed transactions are automatic chargeback-eligible transactions, and separate the automatic chargeback-eligible transactions from the plurality of processed transactions. The AC computing device may determine that the processed transactions are automatic chargeback-eligible transactions by determining whether the processed transactions satisfy rules and/or requirements of chargebacks transactions (e.g., disputable transactions that require chargebacks). For example, as described herein, the AC computing device may determine that automatic chargeback-eligible transactions are associated with (i) transactions initiated with a not-on-file account identifier (e.g., phony account identifiers that are not associated with legitimate accounts issued by an issuing bank), (ii) transactions that do not include a valid authorization message (e.g., authorization messages that are not valid for a particular transaction or authorization messages that indicate that the authorization request was declined), (iii) transactions that do not include a valid clearing message from a merchant associated with the transactions following the expiration of a period of time (e.g., clearing messages being processed over the processing payment network and received within a certain period of time), and/or (iv) transactions initiated with an account identifier associated with an account that is in bad standing with the issuer of the account (e.g., accounts having zero balance or negative balance and/or a suspended/inactive status).

Once transactions are determined to be automatic chargeback-eligible transactions, the AC computing device aggregates the chargeback-eligible transactions into a single data file. The AC computing device then formats the single data file into a standardized format such that the single file may be easily transmitted and read. To automatically initiate the chargeback transactions for the determined automatic chargeback-eligible transactions, the AC computing device transmits the single data file including the chargeback-eligible transactions to the payment processor. Specifically, the AC computing device transmits the single data file to a dispute case manager (DCM) of the payment processor such that the DCM may begin the chargeback transaction processing (e.g., over a chargeback processing network).

The technical problems addressed by the disclosure include at least one of: (i) substantial human resources necessary to determine and process chargeback transactions (e.g., for payment processing networks, issuing banks, and cardholders), (ii) substantial processing power necessary to determine and process chargeback transactions, (iii) inability to automatically determine and initiate chargeback transactions, especially for dual message transactions, and (iv) the need for human interaction in the chargeback process (e.g., to determine and/or flag transactions that require a chargeback and to process chargeback transactions).

The resulting technical benefits and effects achieved by the systems and methods of the disclosure include at least one of: (i) automatically determining chargeback-eligible transactions, (ii) automatically initiating chargeback transactions for the determined chargeback-eligible transactions, (iii) initiating chargeback transactions by combining all determined chargeback-eligible transactions over a predetermined time period (e.g., every four-six hours, every day, etc.) into one file such that the chargeback-eligible transactions can be sent in a single, standardized file format, (iv) reducing the processing power required to process chargeback transactions, and (v) eliminating the need for human interaction to determine and verify chargeback transactions for transactions that satisfy certain rules/requirements associated with automatic chargeback-eligible transactions.

The methods and systems directed to the AC computing device described herein may be implemented using computer programming or engineering techniques including computer software, firmware, hardware or any combination or subset thereof, wherein the technical effect may be achieved by performing at least one of the following steps: (i) receiving transaction data associated with a plurality of processed transactions, the transaction data including a plurality of account identifiers, a plurality of authorization messages, and a plurality of clearing messages associated with the plurality of processed transactions, (ii) matching the plurality of authorization messages with the respective plurality of clearing messages for each processed transaction of the plurality of processed transactions, (iii) identifying automatic chargeback-eligible transactions from the plurality of processed transactions by parsing the transaction data and by the matching of the authorization messages with the clearing messages, (iv) storing, in the at least one memory, the identified automatic chargeback-eligible transactions, (v) automatically initiating a chargeback transaction for each identified automatic chargeback-eligible transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality. The following detailed description illustrates embodiments of the disclosure by way of example and not by way of limitation. It is contemplated that the disclosure has general application to providing an automatic chargeback (AC) computing system/device to automatically determine chargeback-eligible transactions based upon transaction data.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PCAs), and key fobs.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database implementation (e.g., relational, document-based) may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, transaction data includes any account, transaction, merchant, issuer, authorization, and/or clearing data associated with a transaction. Transaction data may include account identifiers (e.g., payment account numbers (PANs), bank identifier numbers (BINs), etc.), account information (e.g., whether accounts are in good standing or bad standing), payment card types, transaction amounts, item identifiers, merchant identifiers, merchant locations, merchant category codes, issuing bank, authorization messages, clearing messages, transaction identifiers, etc.

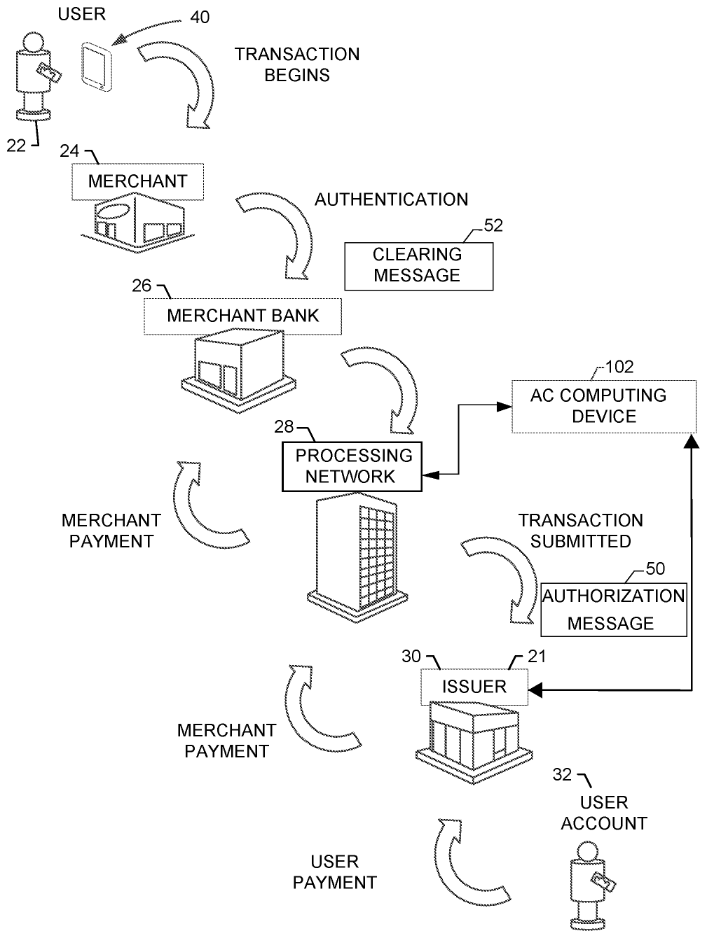

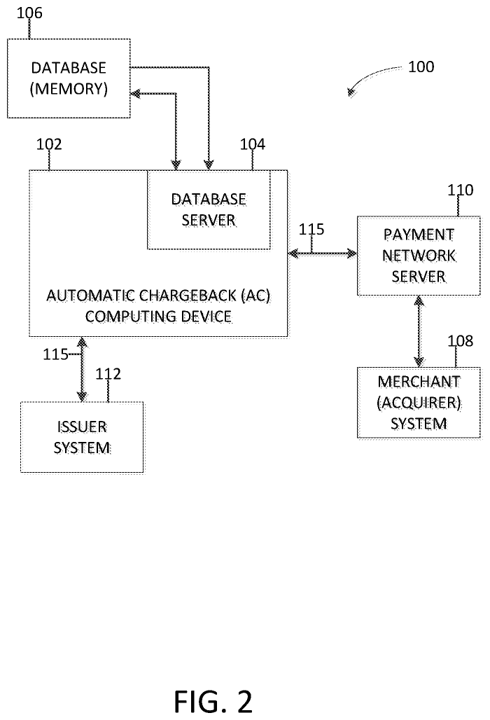

FIG. 1 illustrates a schematic diagram of an example multi-party payment account system for enabling payment transactions initiated by cardholders (e.g., user 22) over a payment processing network 28 that is in communication with an automatic chargeback (AC) computing device 102. AC computing device 102 is configured to collect transaction data from the processed payment transactions and automatically initiate chargeback transactions for those payment transactions that are determined to be chargeback-eligible transactions. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, AC computing device 102 is communicatively coupled to processing network 28 and an issuer 30. AC computing device 102 is configured to receive transaction data from processing network 28 to automatically determine and initiate chargeback-eligible transactions. In the exemplary embodiment, the payment transactions may include dual message transactions, debit transactions, and prepaid transactions. As used herein, processing network 28 may be directly connected to AC computing device 102, or may be indirectly connected to AC computing device 102 through a gateway system (not shown).

In the exemplary embodiment, a financial institution called the “issuer” or “issuing bank” issues an account, such as a credit card account, a debit account, or a prepaid card account to cardholder 22, who uses the account to tender payment for a purchase from a merchant 24. In one embodiment, cardholder 22 presents a payment card and/or a digital wallet to merchant 24 using a user computing device (also known as card-present transactions). In another embodiment, the user does not present a digital wallet and instead performs a card-not-present transaction. For example, the card-not-present transaction may be initiated via a digital wallet application, through a website or web portal, via telephone, or any other method that does not require the user to present a physical payment card to merchant 24 (e.g., via swiping or inserting the payment card and/or scanning the digital wallet).

To accept payment with the transaction card, merchant 24 establishes an account with a financial institution that is part of the financial payment system. This financial institution is usually called the “merchant bank,” the “acquiring bank,” or the “acquirer.” In one embodiment, cardholder 22 tenders payment for a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads account information of cardholder 22 from a magnetic stripe, a chip, barcode, or embossed characters on the transaction card (e.g., a debit card or a prepaid card) and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using processing network 28, computers of merchant bank 26 or merchant processor will communicate with computers of an issuer bank 30 to determine whether an account 32 of cardholder 22 is in good standing and whether the purchase is covered by an available credit line of cardholder 22. Based on these determinations, the request for authorization will be declined or accepted. If the request is accepted, an authorization code (e.g., included in an authorization message 50) is issued to merchant 24. Authorization message 50 includes a transaction identifier associated with the transaction and an indicator indicating that the transaction was authorized. If the request is not accepted, authorization message 50 includes a transaction identifier associated with the transaction and an indicator indicating that the transaction was declined. In the example embodiment, authorization message 50 is formatted according to ISO 8583 network messaging protocol or the equivalent messaging protocol used by the payment card processing network.

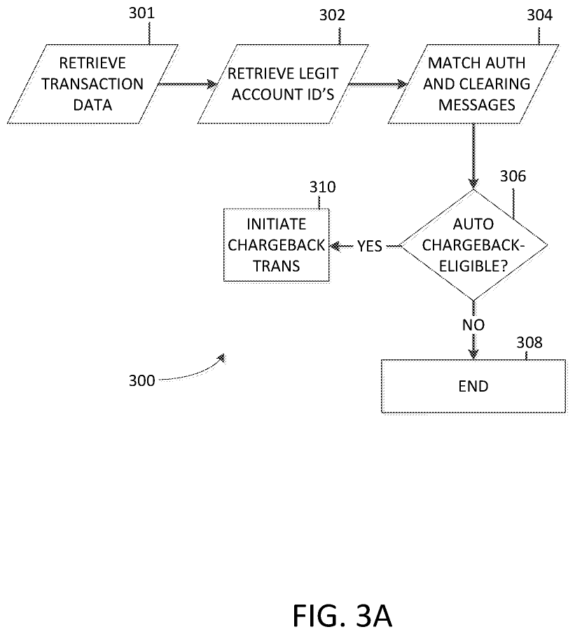

When a request for authorization is accepted, the available credit line of account 32 of cardholder 22 is decreased. Normally, a charge for a payment card transaction is not posted immediately to account 32 of cardholder 22 because certain rules do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Processing network 28 and/or issuer bank 30 stores the transaction card information, such as a type of merchant, amount of purchase, date of purchase, etc. in a database 106 (shown in FIG. 2).

After a purchase has been made, a clearing process occurs to transfer additional transaction data related to the purchase among the parties to the transaction, such as merchant bank 26, processing network 28, and issuer bank 30. More specifically, during and/or after the clearing process, additional data included in a clearing message 52, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, clearing message 52 is formatted according to ISO 8583 network messaging protocol or the equivalent messaging protocol used by the payment card processing network.

After a transaction is authorized and cleared, the transaction is settled among merchant 24, merchant bank 26, and issuer bank 30. Settlement refers to the transfer of financial data or funds among account of merchant 24, merchant bank 26, and issuer bank 30 related to the transaction. Usually, transactions are captured and accumulated into a “batch,” which is settled as a group. More specifically, a transaction is typically settled between issuer bank 30 and processing network 28, and then between processing network 28 and merchant bank 26, and then between merchant bank 26 and merchant 24.

As described above, the various parties to the payment card transaction include one or more of the parties shown in FIG. 1 such as, for example, cardholder 22, merchant 24, merchant bank 26, processing network 28 (also referred to herein as payment processor 28), issuer bank 30, and/or an issuer processor 21.

Occasionally, transactions processed by processing network 28 are disputable (e.g., fraudulent transactions, transactions carried out with bad standing accounts, or otherwise disputable by the account holders or issuer), and chargebacks may be necessary to correct the disputable transactions (e.g., by crediting accounts associated with the disputable transactions such that the users associated with the accounts are not accountable for the disputable transactions). In known chargeback processing systems, cardholder 22, users associated with processing network 28, and/or users associated with issuer 30 determine that a disputable transaction has taken place. For example, cardholder 22 may check a statement associated with the payment card of the cardholder and notice that there are one or more transactions on the statement that were disputable (e.g., fraudulent transactions not initiated by cardholder 22 or with permission from cardholder 22). In these scenarios, cardholder 22 may alert issuer 30 of the payment card and/or processing network 28 associated with the payment card to initiate the chargeback process. For example, the chargeback process includes forwarding the chargeback dispute to a dispute case manager of processing network 28 where the chargeback dispute is processed over a chargeback network (e.g., payment processing network 28 or another network substantially similar to payment processing network 28) by forwarding the chargeback dispute onto acquiring bank 26 or merchant 24 for dispute responses. Further, for example, users associated with processing network 28 may determine that a disputable transaction has taken place when a fraudulent user uses a fraudulent account number and forces merchant 24 to clear the transaction (e.g., when the fraudulent user has compromised merchant 24). In these scenarios, users associated with processing network 28 and/or issuer 30 must manually research and pull flagged transactions to determine whether a chargeback dispute should be initiated (e.g., forwarding onto acquiring bank 26 or merchant 24 for dispute response). Typical chargeback processes, and specifically determining that chargeback disputes are necessary and initiating chargeback transactions based upon the determination, are arduous processes that require substantial human effort. AC computing device 102 remedies the deficiencies of known chargeback processes by automatically determining that chargebacks are necessary without human input. Specifically, AC computing device 102 uses rules/requirements (e.g., as specified by processing network 28 and/or issuer 30) to determine automatic chargeback-eligible transactions and automatically initiate chargeback transactions for the automatic chargeback-eligible transactions, as described herein.

AC computing device 102 is communicatively coupled to processing network 28 and issuer 30. In some embodiments, AC computing device 102 may be directly communicatively coupled to processing network 28 (e.g., a Mastercard interchange network). In other embodiments, AC computing device 102 may be indirectly communicatively coupled to processing network 28. For example, AC computing device 102 may communicate with a third-party processing network 28 and/or third-party payment processor through a gateway communication system.

FIG. 2 is an expanded block diagram of an example embodiment of an automatic chargeback (AC) platform 100 that includes automatic chargeback (AC) computing device 102, which is configured to receive transaction data that is associated with a plurality of processed payment transactions, analyze the transaction data, identify certain transactions within the transaction data that are chargeback-eligible transactions, and then initiate the chargeback transaction for each chargeback-eligible transaction. In the example embodiment, AC platform 100 is used to automatically determine and initiate chargeback transactions. In some embodiments, AC computing device 102 may be supported by or be in communication with processing network 28 and/or issuer processor 21 (shown in FIG. 1).

More specifically, in the example embodiment, AC platform 100 includes an AC computing device 102 and one or more client sub-systems connected to AC computing device 102 through a payment network server 110. Client sub-systems include one or more merchant systems 108 (also referred to as merchant computing device 108 and merchant device 108). In one embodiment, merchant device 108 is a computer including a web browser, such that payment network server 110 is accessible to merchant device 108 using the Internet and/or using another network. Merchant device 108 is interconnected to the Internet through many interfaces including a network, such as a local area network (LAN) or a wide area network (WAN), dial-in-connections, cable modems, special high-speed Integrated Services Digital Network (ISDN) lines, and RDT networks. Merchant device 108 includes systems associated with merchants 24 and/or merchant banks 26 (shown in FIG. 1) as well as external systems used to store data. For example, merchant system 108 may be a POS device communicatively coupled to an external system of merchants 24. AC computing device 102 is also in communication with payment network server 110 associated with processing network 28 (shown in FIG. 1) and an issuer system 112 (also referred to herein as an issuer server 112) associated with issuer 30 (shown in FIG. 1) using a network 115. Further, merchant systems 108 may communicate with processing network 28 using network 115 and/or an another network. Merchant systems 108 could be any device capable of interconnecting to the Internet including a web-based phone, PDA, or other web-based connectable equipment.

A database server 104 is connected to database 106, which contains information on a variety of matters, as described below in greater detail. In one embodiment, centralized database 106 is stored on AC computing device 102 and can be accessed by payment network server 110 and/or issuer system 112. Access to centralized database 106 is controlled by AC computing device 102 to limit the display of data to authorized users associated with AC computing device 102. In an alternative embodiment, database 106 is stored remotely from AC computing device 102 and may be non-centralized. Database 106 may be a database configured to store information used by AC computing device 102 including, for example, transaction data, authorization message data, clearing message data, transaction card data (e.g., issued account identifiers and status), rules data (e.g., as specified by processing network 28 and/or issuer 30), chargeback data, and/or other data.

Database 106 may include a single database having separated sections or partitions, or may include multiple databases, each being separate from each other. In some embodiments, database 106 stores transaction data generated over the processing network including data relating to merchants, consumers, account holders, prospective customers, issuers, acquirers, and/or purchases made. In additional embodiments, database 106 also stores account data including at least one of a cardholder name, a cardholder address, one or more primary account numbers (PANs), other account identifiers, and transaction information. Database 106 may also store merchant information including a merchant identifier that identifies each merchant registered to use the network, and instructions for settling transactions including merchant bank account information. Database 106 may also store purchase data associated with items being purchased by a cardholder from a merchant, authorization request data, authorization messages, and clearing messages.

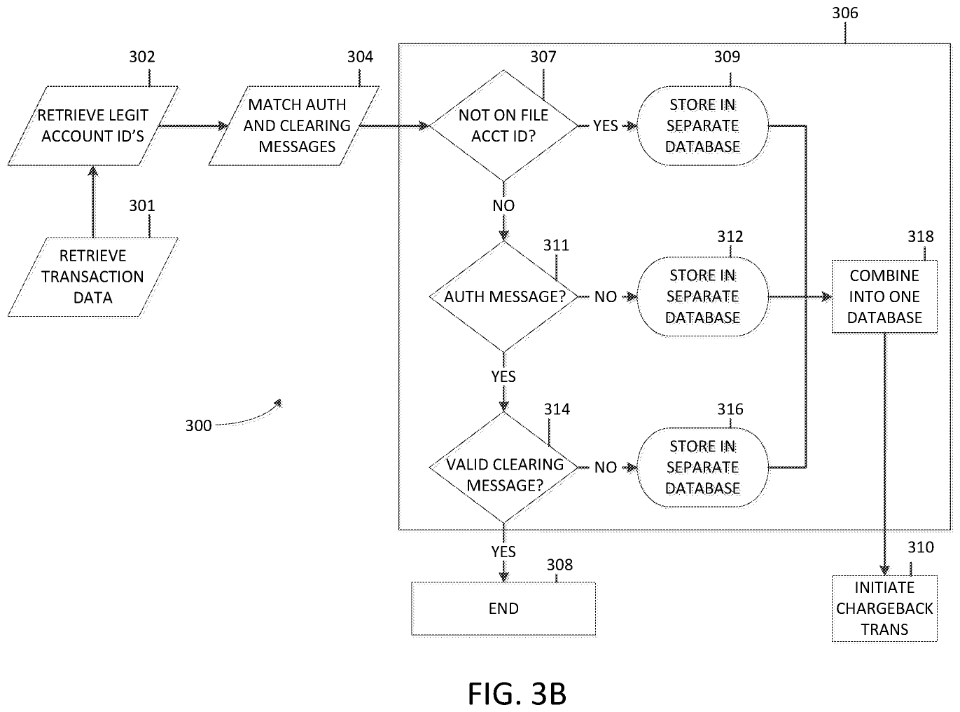

FIGS. 3A and 3B are data flow block diagrams illustrating an example process 300 of automatically determining and initiating chargeback transactions in accordance with an example embodiment of the present disclosure. FIG. 3A illustrates a high-level block diagram of process 300, and FIG. 3B shows additional steps of process 300 (e.g., determining whether transactions are automatic chargeback-eligible transactions). In some embodiments, process 300 is implemented by AC computing device 102 (shown in FIG. 2).

Process 300 includes retrieving 301 processed transaction data and retrieving 302 legitimate account identifiers. The legitimate account identifiers are associated with legitimate payment accounts issued by an issuing bank (e.g., issuer 30, shown in FIG. 1). In some embodiments, the legitimate account identifiers are retrieved 302 from the issuing banks. In other embodiments, the legitimate account identifiers are retrieved 302 from a database associated with AC computing device 102 (e.g., database 106, shown in FIG. 1). In some further embodiments, the legitimate account identifiers and the transaction data may be retrieved from processing network 28 (e.g., in a standardized format and/or in a single message). In these embodiments, the legitimate account identifiers are retrieved 302 from payment processor 28 at the same time the transaction data (e.g., authorization and clearing messages) is retrieved 301 from payment processor 28. The processed transaction data is associated with processed transactions that are processed over a payment processor (e.g., processing network 28, shown in FIG. 1). The processed transaction data includes data associated with processed payment transactions (e.g., account identifiers, authorization messages, clearing messages, transaction identifiers, merchant identifiers, etc.).

Further, process 300 includes matching 304 authorization and clearing messages for the processed transactions. Authorization messages and clearing messages may be matched 304 according to matching transaction identifiers included in the authorization and clearing messages. In other words, an authorization message associated with a particular transaction is matched with a clearing message that is also associated with the same particular transaction. Thus, AC computing device 102 is able to match each authorization message with a corresponding or related clearing message. AC computing device 102 may store retrieved 302 legitimate account identifiers, retrieved 301 transaction data, and matched 304 authorization and clearing messages in a database (e.g., database 106) or any other suitable memory device.

Process 300 includes determining 306 whether the processed transactions are automatic chargeback-eligible transactions, as described below in greater detail with respect to steps 307, 309, 311, 312, 314, 316, and 318. That is, process includes determining 306 whether each processed transaction is (i) a transaction initiated with a not-on-file account identifier (e.g., phony account identifiers that are not associated with legitimate accounts issued by an issuing bank), (ii) a transaction that does not include a valid authorization message (e.g., authorization messages that are not valid for a particular transaction or authorization messages that indicate that the authorization request was declined), (iii) a transaction that does not include a valid clearing message from a merchant associated with the transactions following the expiration of a period of time (e.g., clearing messages being processed over the payment network), and/or (iv) a transaction initiated with an account identifier associated with an account that is in bad standing with the issuer of the account (e.g., accounts having zero balance or negative balance and/or a suspended/inactive status). If any of the processed transactions are not associated with one of the transactions listed, AC computing device 102 determines 306 that those processed transactions are not automatic chargeback-eligible transactions, and process 300 is ended 308. If any of the processed transactions are associated with one of the transactions listed, AC computing device 102 determines 306 that those processed transactions are automatic chargeback-eligible transactions. Accordingly, process 300 includes automatically initiating 310 chargeback transactions for the automatic chargeback-eligible transactions, as described below.

A first step of determining 306 whether the processed transactions are automatic chargeback-eligible transactions includes determining 307 whether the account identifiers associated with the processed transactions are “on-file” account identifiers or “not-on-file” account identifiers. That is, AC computing device 102 compares each retrieved account identifier (from retrieved 301 transaction data associated with processed transactions) to retrieved 302 legitimate account identifiers to identify whether each retrieved account identifiers matches one of the retrieved 302 legitimate account identifiers. For example, in some disputable transactions, fraudulent users may generate fraudulent account identifiers that look like legitimate account identifiers associated with an issuer 30, even though the account identifiers were never issued by issuer 30 and are illegitimate. In these embodiments, the fraudulent users may further compromise merchants (e.g., merchant 24 and/or merchant bank 26) and force the transactions through even though the transactions are not associated with a legitimate account. If the retrieved account identifier matches one of the retrieved 302 legitimate account identifiers, the account identifier is identified as an “on-file” account identifier. If the retrieved account identifier does not match one of the retrieved 302 legitimate account identifiers, the account identifier is identified as a “not-on-file” account identifier.

The processed transactions associated with “not-on-file” account identifiers are determined 307 to be automatic chargeback-eligible transactions, and those processed transactions are stored 309 in a separate database (or other suitable memory device) of AC computing device 102. The processed transactions associated with “on-file” account identifiers are transmitted to the next step of determining 311 if valid authorization messages are present in the processed transactions.

AC computing device 102 determines 311 whether valid authorization messages are included in the processed transactions associated with on-file account identifiers. That is, AC computing device 102 determines 311 if each processed transaction includes a valid authorization message indicating that the processed transaction was authorized. As described herein, invalid authorization messages are transactions that do not include an authorization message that was processed over processing network 28 or includes an authorization message that was declined by the issuer (e.g., issuer 30). For example, in some disputable transactions, fraudulent users may compromise merchant 24 and/or merchant bank 26 (e.g., through a data or system hack) such that it looks like a processed transaction has been authorized by the issuer even though there is no actual authorization message processed by the network or there is an authorization message but it shows a declined authorization. Further, in some embodiments, invalid authorization messages may include authorization messages without a matching clearing message. If the processed transactions include a valid authorization message, the processed transactions are determined 311 to be “present” authorization message transactions. If the processed transactions do not include a valid authorization message (e.g., if there was no authorization message or there was an authorization message but the authorization message indicates that the authorization was declined), the processed transactions are determined 311 to be “invalid” authorization message transactions.

The processed transactions associated with invalid authorization message transactions are determined 311 to be automatic chargeback-eligible transactions and are stored 312 in a separate database (or other suitable memory device) of AC computing device 102. The processed transactions associated with present authorization message transactions are transmitted to the next step of determining 314 whether valid clearing messages are present in the processed transactions.

AC computing device 102 also determines 314 whether valid clearing messages are included in the processed transactions associated with present authorization message transactions. That is, AC computing device 102 determines 314 whether each processed transaction includes a valid clearing message that was processed over processing network 28 within a predetermined time period of initiating the transaction. The predetermined time period may be a week, two weeks, a month, etc. Valid clearing messages do not include any flags (e.g., indicating that the transaction may have been disputable or fraudulent, that the clearing and authorization messages do not match, etc.), include additional clearing data received by processing network 28 within the predetermined time period, and match the authorization message. Invalid clearing messages include clearing messages received after the predetermined time period, include flags noting that the transaction was a disputable or fraudulent transaction or associated with a not-on-file account identifier, or clearing messages that do not match the authorization messages for the processed transactions. For example, since clearing messages must be transmitted by merchant 24 within the predetermined time period over the processing network (e.g., for merchants 24 to be within a chargeback protection period), associated merchants 24 that generate late associated clearing messages processed over the processing network are not protected from chargebacks. Accordingly, processed transactions with late/invalid clearing messages are determined 314 to be automatic chargeback-eligible transactions. If the processed transactions include a valid clearing message, the processed transactions are determined 314 to be “valid” clearing message transactions. If the processed transactions do not include a valid clearing message after the predetermined time period, the processed transactions are determined 314 to be “invalid” clearing message transactions.

When the processed transactions are determined to not be automatic chargeback-eligible transactions (e.g., if the transactions are associated with on-file account identifiers, valid/present authorization messages, and valid clearing messages), process 300 ends 308 for those processed transactions. That is, no chargeback transactions are automatically initiated for those processed transactions.

The processed transactions associated with invalid clearing message transactions are stored 316 in a separate database (or other suitable memory device) of AC computing device 102.

The processed transactions stored 309, 312, and 316 in separate databases are aggregated and formatted 318 by AC computing device 102 into a standardized, single file. The standardized, single file may include a standardized database file including each of the processed transactions. Once the processed transactions (the automatic chargeback-eligible transactions) are aggregated and formatted 318, AC computing device 102 initiates 310 chargeback transactions for the automatic chargeback-eligible transactions. In initiating 310 the chargeback transactions, AC computing device 102 transmits the aggregated and formatted 318 file to a dispute case manager (DCM) associated with processing network. The DCM handles the processing of the chargeback transactions such that the chargeback transactions may be settled.

Process 300 may include further steps to determine automatic chargeback-eligible transactions. For example, process 300 may include determining, through clearing messages of the received transactions, if the accounts associated with the transactions are in good standing or in bad standing. Accounts in good standing include accounts with sufficient funds to carry out the processed transactions associated with the accounts and/or accounts that have not been restricted/deactivated by issuer 30. Accounts in bad standing include accounts with insufficient funds (e.g., negative or zero balance) to carry out the processed transactions associated with the accounts and/or accounts that have been restricted/deactivated by issuer 30. Accordingly, processed transactions associated with bad standing accounts may be determined to be automatic chargeback-eligible transactions, and AC computing device 102 may automatically initiate chargeback transactions for these processed transactions. In some embodiments, processed transactions associated with accounts in bad standing may not include valid authorization messages. In other embodiments, processed transactions associated with accounts in bad standing may include valid authorization messages due to authorization systems being compromised and/or error. Accordingly, it may be necessary to specifically identify accounts in good standing and accounts in bad standing.

Further, processing network 28 and/or issuers 30 may specify certain rules/requirements associated with automatic chargeback-eligible transactions. Accordingly, processing network 28 and/or issuers 30 may instruct AC computing device 102 to automatically initiate chargeback transactions for the automatic chargeback-eligible transactions. That is, AC computing device 102 can dynamically determine automatic chargeback-eligible transactions and initiate the chargeback transactions according to the rules/requirements of different processing networks and issuers.

In some embodiments, processed transaction data is retrieved 301 in batches at predetermined times. For example, processed transaction data may be retrieved 301 (e.g., from processing network 28) every six hours throughout the day starting at midnight. Accordingly, process 300 may be implemented by AC computing device 102 each time the batches are retrieved 301. In other embodiments, processed transaction data may be retrieved in real-time or near-real-time, and process 300 may be implemented by AC computing device 102 in real-time or near-real-time. In further embodiments, process 300 may be implemented by AC computing device 102 at any suitable time (e.g., every four hours, twice every day, once every day, etc.).

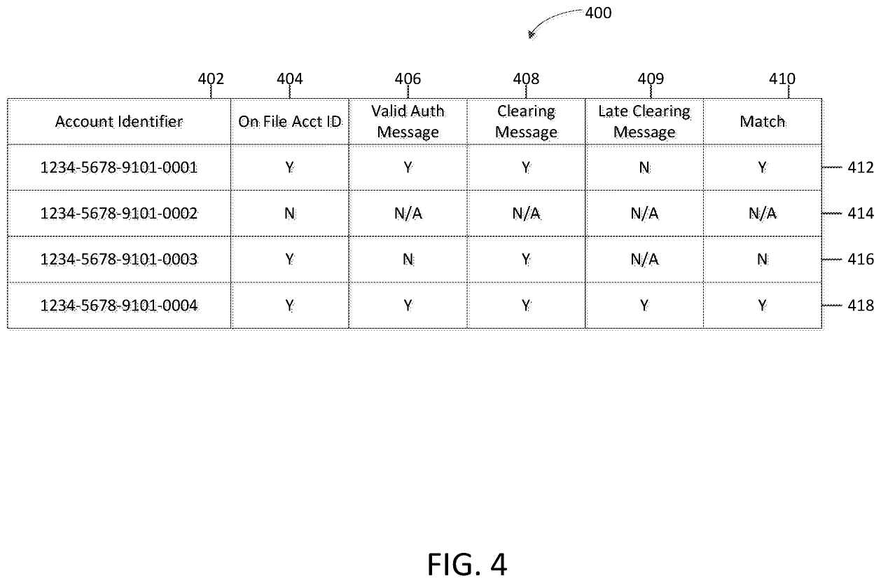

FIG. 4 is a simplified diagram of an example table 400 that includes transaction data and data generated/determined by AC computing device 102 shown in FIG. 1. Table 400 could be stored in database 106 (shown in FIG. 2).

In the illustrated embodiment, table 400 includes a field 402 indicating the account identifiers associated with each processed transaction, a field 404 indicating whether the account identifier associated with the processed transactions are on-file, a field 406 indicating whether a valid authorization message is present for the processed transaction, a field 408 indicating whether a valid clearing message is present for the processed transaction, a field 409 indicating whether the clearing message was late, and a field 410 indicating whether an authorization message and a clearing message of the processed transaction match (e.g., are both present and valid). AC computing device 102 determines the account identifier, whether there is an on-file account identifier, a valid authorization message, a valid clearing message, whether the clearing message was late, and whether the authorization messages and clearing messages match for each processed transaction and populates fields 402, 404, 406, 408, 409, and 410 based upon the determinations for each processed transaction 412, 414, 416, and 418.

As shown in table 400, processed transaction 412 would not be determined to be an automatic chargeback-eligible transaction automatically initiated by AC computing device 102 because processed transaction 412 has an on-file account identifier, a valid authorization message, a valid clearing message, a timely clearing message, and the authorization message and clearing message match. However, processed transaction 414 shown in table 400 would be determined to be an automatic chargeback-eligible transaction by AC computing device 102 because processed transaction 414 was not initiated using an on-file account identifier, and thus, no further fields 406, 408, 409, or 410 would need to be populated/considered by AC computing device 102 to automatically initiate the chargeback transaction. Also, processed transaction 416 would be determined to be an automatic chargeback-eligible transaction by AC computing device 102 because although processed transaction 416 was initiated using an on-file account identifier and includes a valid clearing message, processed transaction 416 does not include a valid authorization message. Accordingly, the authorization and clearing messages of processed transaction 416 do not match. For example, processed transaction 416 may be associated with a transaction where a fraudulent user forced clearing of processed transaction 416 through compromised merchant data or a compromised merchant system. Further, processed transaction 418 would also be determined to be an automatic chargeback-eligible transaction by AC computing device 102 because although processed transaction 418 was initiated using an on-file account identifier, includes a valid authorization message, a clearing message, and the authorization message and clearing message match, processed transaction 418 includes a late clearing message. For example, processed transaction 418 may be associated with a transaction where a merchant does not clear the transaction (e.g., and transmit the clearing message over the processing network) within the chargeback protection period.

In other embodiments, table 400 includes additional, alternate, or different data fields and/or formatting. For example, table 400 may further include a field identifying whether the account associated with the account identifier is in good standing. Further, table 400 may include fields specified by processing network 28 and/or issuer 30 associated with the rules and requirements of processing network 28 and/or issuer 30.

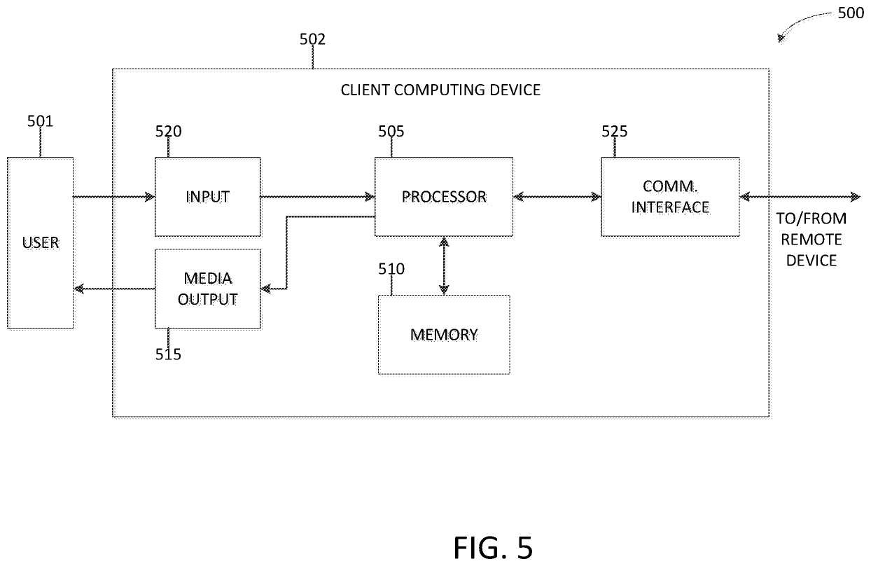

FIG. 5 illustrates an example configuration of a client computing device 502. Client computing device 502 may include, but is not limited to, merchant system 108 (shown in FIG. 1). Client computing device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer-readable media.

Client computing device 502 also includes at least one media output component 515 for presenting information to a user 501 (e.g., merchant 24, shown in FIG. 1). Media output component 515 is any component capable of conveying information to user 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 502 includes an input device 520 for receiving input from user 501. Input device 520 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 515 and input device 520.

Client computing device 502 may also include a communication interface 525, which is communicatively couplable to a remote device such as a server system (e.g., server system 501 shown in FIG. 5) or a web server. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server. A client application allows users 501 to interact with a server application associated with, for example, an automatic chargeback system. The user interface, via one or both of a web browser and a client application, facilitates displaying chargeback disputes generated by AC computing device 102. The user may interact with the user interface to view and respond to chargeback disputes using input device 520.

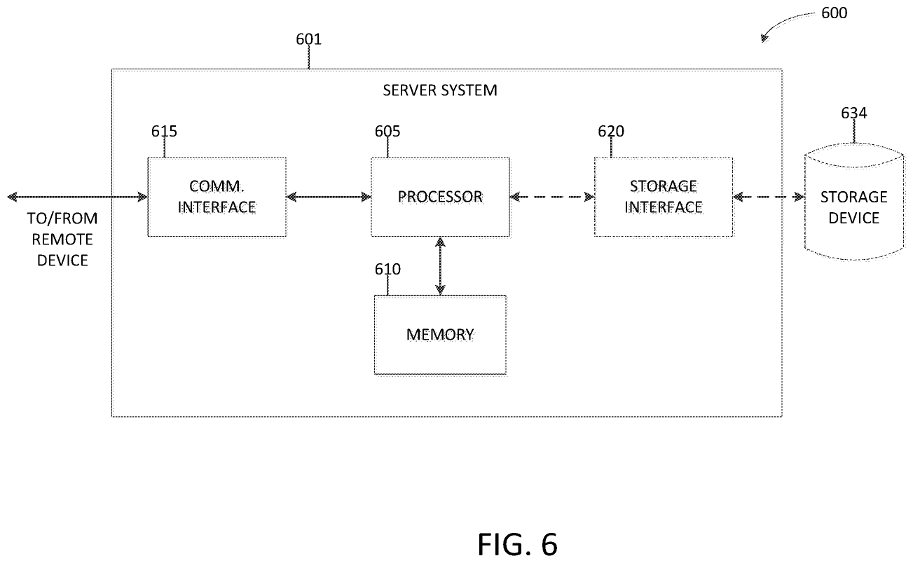

FIG. 6 illustrates an example configuration of a server (host computing device) system 601 such as AC computing device 102, payment network server 110, and/or issuer system 112 (shown in FIG. 2) used to receive transaction data associated with payment transactions, match authorization messages and clearing messages from the transactions, determine a transaction type for the transactions, store, in a database (e.g., database 106, shown in FIG. 2), account numbers, matched authorization and clearing messages, and transaction types for the payment transactions, perform lookups in the database to determine automatic chargeback-eligible transactions, and transmit the automatic chargeback-eligible transactions to a payment processor for chargeback processing.

Server system 601 includes a processor 605 for executing instructions. Instructions may be stored in a memory area 610, for example. Processor 605 may include one or more processing units (e.g., in a multi-core configuration) for executing instructions. The instructions may be executed within a variety of different operating systems on the server system 601, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 605 is operatively coupled to a communication interface 615 such that server system 601 is capable of communicating with a remote device such as another server system 601. For example, communication interface 615 may receive requests (e.g., requests to display automatic chargeback-eligible transactions and chargeback disputes) from payment network server 110 and/or issuer system 112 via the Internet, as illustrated in FIG. 2.

Processor 605 may also be operatively coupled to a storage device 634. Storage device 634 is any computer-operated hardware suitable for storing and/or retrieving data. In some embodiments, storage device 634 is integrated in server system 601. For example, server system 601 may include one or more hard disk drives as storage device 634. In other embodiments, storage device 634 is external to server system 601 and may be accessed by a plurality of server systems 601. For example, storage device 634 may include multiple storage units such as hard disks or solid state disks in a redundant array of inexpensive disks (RAID) configuration. Storage device 634 may include a storage area network (SAN) and/or a network attached storage (NAS) system. In some embodiments, server system 601 also includes database server 104 (shown in FIG. 2).

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Memory area 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

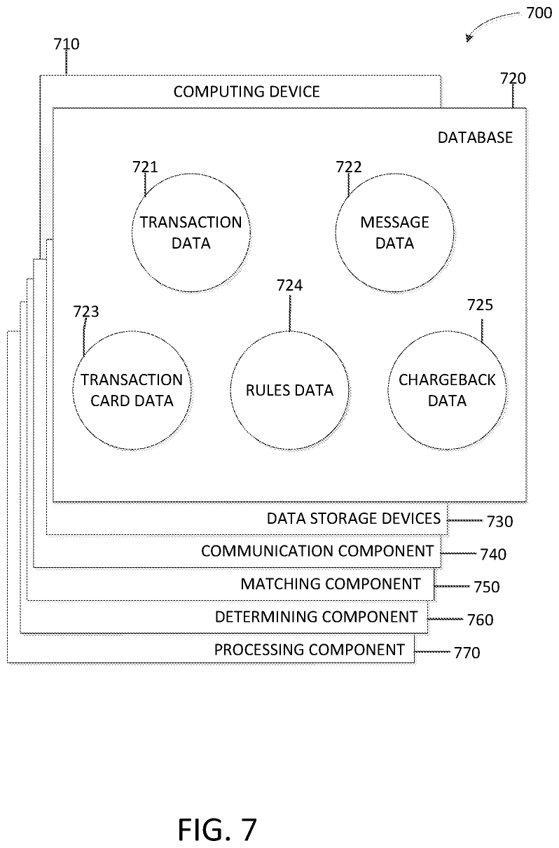

FIG. 7 is a diagram of components 700 of one or more example computing devices 710 (e.g., AC computing device 102) that may be used in the environment shown in FIG. 2. Computing device 710 includes database 720 as well as data storage devices 730, a communication component 740, a matching component 750, a determining component 760, and a processing component 770. Database 720 may store information such as, for example, transaction data 721, message data 722 (e.g., authorization and clearing messages), transaction card data 723 (e.g., account numbers, bank identification numbers associated with transaction/payment cards, account status, etc.), rules data 724 (e.g., as specified by processing network 28 and/or issuer 30, as shown in FIG. 1), chargeback data 725, and/or other data. Transaction data 721 is data related to transactions processed by one or more payment processing networks. Database 720 is coupled to several separate components within AC computing device 102, which perform specific tasks. In some embodiments, database 720 is substantially similar to database 106 (shown in FIG. 2).

Communication component 740 facilitates communication between computing device 710 and other systems (e.g., payment network server 110 and/or issuer system 112, as shown in FIG. 2). Matching component 750 is used to match transaction data with respective additional transaction data (e.g., account numbers, transaction types, authorization messages, and clearing messages). Determining component 760 is used to determine automatic chargeback-eligible transactions (e.g., based upon predetermined rules associated with automatic chargeback-eligible transactions). Processing component 760 processes transaction data, automatic chargeback-eligible transactions, and the initiation of chargeback disputes.

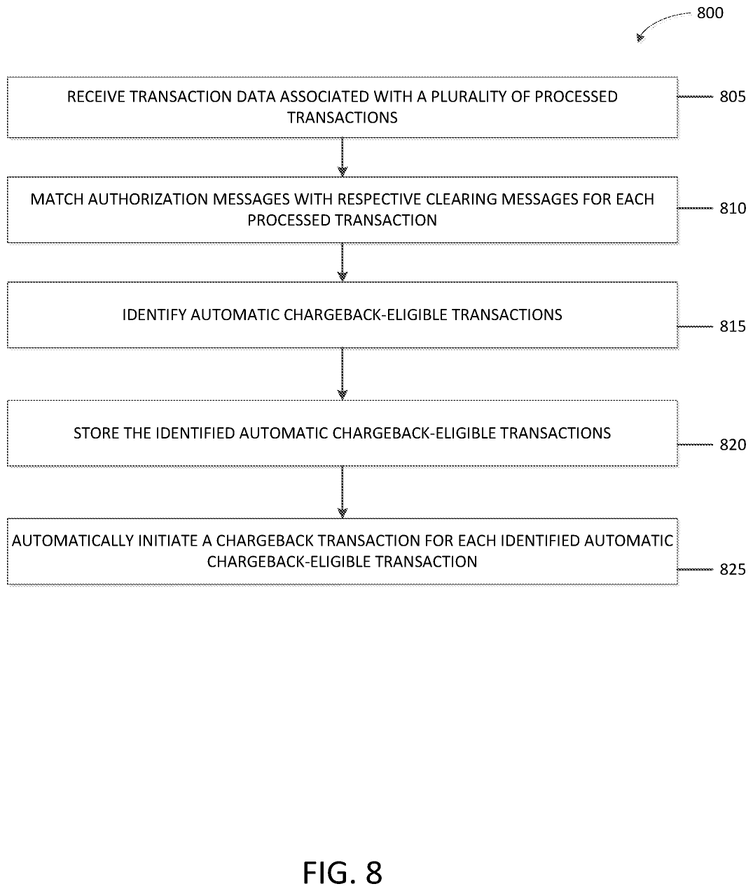

FIG. 8 illustrates a flow chart of an exemplary method 800 for determining chargeback-eligible transactions. Method 800 may be carried out by automatic chargeback (AC) computing device 102 (shown in FIG. 2).

In the example embodiment, method 800 includes receiving 805 transaction data associated with a plurality of processed transactions. The received 805 transaction data includes a plurality of account identifiers, a plurality of authorization messages, and a plurality of clearing messages associated with the plurality of processed transactions. Method 800 further includes matching 810 the plurality of authorization messages with the respective plurality of clearing messages for each processed transaction. Automatic chargeback-eligible transactions are identified 815 from the plurality of processed transactions by parsing the transaction data and by the matching 810 of the authorization messages with the clearing messages.

The identified 815 automatic chargeback-eligible transactions are stored 820 in at least one memory (e.g., database 106 of AC computing device 102, shown in FIG. 2). Method 800 further includes automatically initiating 825 a chargeback transaction for each identified 815 automatic chargeback-eligible transaction.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, computer-executable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of fraud analysis for registration of merchants with acquirer banks. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the verification computing module are described herein as including general processing and memory devices, it should be understood that the verification computing module is a specialized computer configured to perform the steps described herein for verifying operation of payment terminals and payment processing networks.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A computing system for automatically initiating a chargeback transaction from a plurality of processed transactions, the computing system comprising at least one processor in communication with at least one memory, the at least one processor programmed to:
receive transaction data associated with a plurality of processed transactions, the transaction data including a plurality of account identifiers, a plurality of authorization messages, and a plurality of clearing messages associated with the plurality of processed transactions;
match the plurality of authorization messages with the respective plurality of clearing messages for each processed transaction of the plurality of processed transactions;
identify automatic chargeback-eligible transactions from the plurality of processed transactions by parsing the transaction data and by the matching of the authorization messages with the clearing messages;
store, in the at least one memory, the identified automatic chargeback-eligible transactions; and
automatically initiate a chargeback transaction for each identified automatic chargeback-eligible transaction.

2. The computing system of claim 1, wherein the at least one processor is further programmed to:
store, in the at least one memory, legitimate account identifiers that are eligible to be used for initiating a transaction;
parse an account identifier from the received transaction data for each transaction of the plurality of processed transactions;
compare each received account identifier of the plurality of account identifiers to the legitimate account identifiers stored in the at least one memory;
identify whether each received account identifier matches any of the legitimate account identifiers stored in the at least one memory;
store, in the at least one memory, the identified account identifiers that do not match any of the legitimate account identifiers as not-on-file account identifiers; and
identify each transaction carried out with a not-on-file account identifier as an automatic chargeback-eligible transaction.

3. The computing system of claim 2, wherein the at least one processor is further programmed to:
store, in the at least one memory, the identified account identifiers that match any of the legitimate account identifiers as on-file account identifiers;
for each processed transaction associated with on-file account identifiers, identify whether each processed transaction of the plurality of processed transactions includes a valid authorization message;
store, in the at least one memory, the identified processed transactions that do not include a valid authorization message as invalid authorization message transactions; and
identify each invalid authorization message transaction as an automatic chargeback-eligible transaction.

4. The computing system of claim 3, wherein the at least one processor is further programmed to:
store, in the at least one memory, the identified transactions that include a valid authorization message as present authorization message transactions;
for each processed transaction associated with valid authorization message transactions, identify whether each processed transaction of the plurality of processed transactions includes a valid clearing message that was processed within a predetermined time period;
store, in the at least one memory, the identified processed transactions that do not include a valid clearing message processed within the predetermined time period as invalid clearing message transactions; and
identify each invalid clearing message transaction as an automatic chargeback-eligible transaction.

5. The computing system of claim 1, wherein the at least one processor is further programmed to:
aggregate each identified automatic chargeback-eligible transaction;
format each aggregated transaction into a single and standardized data file format; and
transmit the formatted single data file to a payment processing network to initiate the chargeback transactions.

6. The computing system of claim 1, wherein the at least one processor is further programmed to:
determine, based upon the plurality of authorization messages, whether each received account identifier is associated with an account that is in one of a good standing and a bad standing, wherein accounts in good standing have at least one of a positive balance, an open status, and an active status, and wherein accounts in bad standing have at least one of a zero balance, a negative balance, a suspended status, and an inactive status;
store, in the at least one memory, the identified account identifiers associated with accounts in bad standing as bad standing account identifiers;
compare each received account identifier of the plurality of account identifiers to the bad standing account identifiers stored in the at least one memory; and
identify each transaction carried out with the bad standing account identifiers as an automatic chargeback-eligible transaction.

7. The computing system of claim 1, wherein the at least one processor is further programmed to:
receive, from an issuer computing device, additional rules associated with automatically initiating chargeback transactions;
identify automatic chargeback-eligible transactions from the plurality of processed transactions based upon the received additional rules; and
automatically initiate chargeback transactions for each identified automatic chargeback-eligible transaction.

8. The computing system of claim 1, wherein the plurality of transactions includes dual message transactions, debit transactions, and prepaid transactions.

9. A computer-implemented method for automatically initiating a chargeback transaction from a plurality of processed transactions, the method implemented by a computing system including at least one processor in communication with at least one memory, the method comprising:
receiving transaction data associated with a plurality of processed transactions, the transaction data including a plurality of account identifiers, a plurality of authorization messages, and a plurality of clearing messages associated with the plurality of processed transactions;
matching the plurality of authorization messages with the respective plurality of clearing messages for each processed transaction of the plurality of processed transactions;
identifying automatic chargeback-eligible transactions from the plurality of processed transactions by parsing the transaction data and by the matching of the authorization messages with the clearing messages;
storing, in the at least one memory, the identified automatic chargeback-eligible transactions; and
automatically initiating a chargeback transaction for each identified automatic chargeback-eligible transaction.

10. The computer-implemented method of claim 9 further comprising:
storing, in the at least one memory, legitimate account identifiers that are eligible to be used for initiating a transaction;
parsing an account identifier from the received transaction data for each transaction of the plurality of processed transactions;
comparing each received account identifier of the plurality of account identifiers to the legitimate account identifiers stored in the at least one memory;
identifying whether each received account identifier matches any of the legitimate account identifiers stored in the at least one memory;
storing, in the at least one memory, the identified account identifiers that do not match any of the legitimate account identifiers as not-on-file account identifiers; and
identifying each transaction carried out with a not-on-file account identifier as an automatic chargeback-eligible transaction.

11. The computer-implemented method of claim 10 further comprising:
storing, in the at least one memory, the identified account identifiers that match any of the legitimate account identifiers as on-file account identifiers;
for each processed transaction associated with on-file account identifiers, identifying whether each processed transaction of the plurality of processed transactions includes a valid authorization message;
storing, in the at least one memory, the identified processed transactions that do not include a valid authorization message as invalid authorization message transactions; and
identifying each invalid authorization message transaction as an automatic chargeback-eligible transaction.

12. The computer-implemented method of claim 11 further comprising:
storing, in the at least one memory, the identified transactions that include a valid authorization message as present authorization message transactions;
for each processed transaction associated with valid authorization message transactions, identifying whether each processed transaction of the plurality of processed transactions includes a valid clearing message that was processed within a predetermined time period;
storing, in the at least one memory, the identified processed transactions that do not include a valid clearing message processed within the predetermined time period as invalid clearing message transactions; and
identifying each invalid clearing message transaction as an automatic chargeback-eligible transaction.

13. The computer-implemented method of claim 12 further comprising:
aggregating each identified automatic chargeback-eligible transaction;
formatting each aggregated transaction into a single and standardized data file format; and
transmitting the formatted single data file to a payment processing network to initiate the chargeback transactions.

14. The computer-implemented method of claim 9 further comprising:
determining, based upon the plurality of authorization messages, whether each received account identifier is associated with an account that is in one of a good standing and a bad standing, wherein accounts in good standing have at least one of a positive balance, an open status, and an active status, and wherein accounts in bad standing have at least one of a zero balance, a negative balance, a suspended status, and an inactive status;
storing, in the at least one memory, the identified account identifiers associated with accounts in bad standing as bad standing account identifiers;
comparing each received account identifier of the plurality of account identifiers to the bad standing account identifiers stored in the at least one memory; and
identifying each transaction carried out with the bad standing account identifiers as an automatic chargeback-eligible transaction.

15. At least one non-transitory computer-readable storage media that includes computer-executable instructions for automatically initiating a chargeback transaction from a plurality of processed transactions, wherein when executed by a computing system including at least one processor in communication with at least one memory, the computer-executable instructions cause the at least one processor to:
receive transaction data associated with a plurality of processed transactions, the transaction data including a plurality of account identifiers, a plurality of authorization messages, and a plurality of clearing messages associated with the plurality of processed transactions;
match the plurality of authorization messages with the respective plurality of clearing messages for each processed transaction of the plurality of processed transactions;
identify automatic chargeback-eligible transactions from the plurality of processed transactions by parsing the transaction data and by the matching of the authorization messages with the clearing messages;
store, in the at least one memory, the identified automatic chargeback-eligible transactions; and
automatically initiate a chargeback transaction for each identified automatic chargeback-eligible transaction.

16. The at least one non-transitory computer-readable storage media of claim 15, wherein the computer-executable instructions further cause the at least one processor to:
store, in the at least one memory, legitimate account identifiers that are eligible to be used for initiating a transaction;
parse an account identifier from the received transaction data for each transaction of the plurality of processed transactions;
compare each received account identifier of the plurality of account identifiers to the legitimate account identifiers stored in the at least one memory;
identify whether each received account identifier matches any of the legitimate account identifiers stored in the at least one memory;
store, in the at least one memory, the identified account identifiers that do not match any of the legitimate account identifiers as not-on-file account identifiers; and
identify each transaction carried out with a not-on-file account identifier as an automatic chargeback-eligible transaction.

17. The at least one non-transitory computer-readable storage media of claim 16, wherein the computer-executable instructions further cause the at least one processor to:
store, in the at least one memory, the identified account identifiers that match any of the legitimate account identifiers as on-file account identifiers;
for each processed transaction associated with on-file account identifiers, identify whether each processed transaction of the plurality of processed transactions includes a valid authorization message;
store, in the at least one memory, the identified processed transactions that do not include a valid authorization message as invalid authorization message transactions; and
identify each invalid authorization message transaction as an automatic chargeback-eligible transaction.

18. The at least one non-transitory computer-readable storage media of claim 17, wherein the computer-executable instructions further cause the at least one processor to:
store, in the at least one memory, the identified transactions that include a valid authorization message as present authorization message transactions;
for each processed transaction associated with valid authorization message transactions, identify whether each processed transaction of the plurality of processed transactions includes a valid clearing message that was processed within a predetermined time period;
store, in the at least one memory, the identified processed transactions that do not include a valid clearing message processed within the predetermined time period as invalid clearing message transactions; and
identify each invalid clearing message transaction as an automatic chargeback-eligible transaction.

19. The at least one non-transitory computer-readable storage media of claim 18, wherein the computer-executable instructions further cause the at least one processor to:
aggregate each identified automatic chargeback-eligible transaction;
format each aggregated transaction into a single and standardized data file format; and
transmit the formatted single data file to a payment processing network to initiate the chargeback transactions.

20. The at least one non-transitory computer-readable storage media of claim 15, wherein the computer-executable instructions further cause the at least one processor to:
determine, based upon the plurality of authorization messages, whether each received account identifier is associated with an account that is in one of a good standing and a bad standing, wherein accounts in good standing have at least one of a positive balance, an open status, and an active status, and wherein accounts in bad standing have at least one of a zero balance, a negative balance, a suspended status, and an inactive status;
store, in the at least one memory, the identified account identifiers associated with accounts in bad standing as bad standing account identifiers;
compare each received account identifier of the plurality of account identifiers to the bad standing account identifiers stored in the at least one memory; and
identify each transaction carried out with the bad standing account identifiers as an automatic chargeback-eligible transaction.
